(19) United States
(12) Patent Application Publication
(10) Pub. No.: US 2007/0077321 A1
(43) Pub. Date: Apr. 5, 2007

(54) Rim molding processes and assemblies for producing golf ball components

(76) Inventors: Thomas A. Veilleux, Charlton, MA (US); David M. Melanson, Northampton, MA (US); Thomas F. Bergin, Holyoke, MA (US)

Correspondence Address: MICHAEL A. CATANIA;CALLAWAY GOLF COMPANY, 2180 RUTHERFORD ROAD, CARLSBAD, CA, 92008-7328, US

(21) Appl. No.: 11/240,855

(22) Filed: Sep. 30, 2005

(51) Int. Cl. B29C 45/14

(52) U.S. Cl. 425/116

(57) ABSTRACT

Molding equipment and related processes for manufacturing golf balls are disclosed. Mold dies particularly adapted for reaction injection molding, and particularly using low viscosity reactants and high temperatures are described. The use of the noted mold dies eliminate or significantly reduce the occurrence of witness lines or other mold defects on golf balls produced therefrom.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to the art of making golf balls. The present invention specifically relates to reaction injection molding of golf ball layers and covers, and related processes.

2. Description of the Related Art

Golf balls are frequently made by molding a core of elastomeric or polymeric material into a spheroid shape. A cover is then molded around the core. Sometimes, before the cover is molded about the core, an intermediate layer is molded about the core and the cover is then molded around the intermediate layer. The molding processes used for the cover and the intermediate layer are similar and usually involve either compression molding or injection molding. The core, intermediate layer and cover may also consist of sub-layers or parts.

In compression molding, the golf ball core is inserted into a central area of a two piece die and pre-sized sections of cover material are placed in each half of the die, which then clamps shut. The application of heat and pressure molds the cover material about the core.

Blends of polymeric materials have been used for modern golf ball covers because certain grades and combinations have offered levels of hardness, damage resistance when the ball is struck with a club, and elasticity, to allow responsiveness when hit. Some of these materials facilitate processing by compression molding, yet disadvantages have arisen. These disadvantages include, among other things, the presence of seams in the cover, which occur where the pre-sized sections of cover material were joined, and high process cycle times which are required to heat the cover material and complete the molding process.

Injection molding of golf ball covers arose as a processing technique to overcome some of the disadvantages of compression molding. The process involves inserting a golf ball core into a die, closing the die and forcing a heated, viscous polymeric material into the die. The material is then cooled and the golf ball is removed from the die. Injection molding is well-suited for thermoplastic materials, but has limited application to some thermosetting polymers. However, certain types of these thermosetting polymers often exhibit the hardness and elasticity, etc., characteristics desired for a golf ball cover. Some of the most promising thermosetting materials are reactive, requiring two or more components to be mixed and rapidly transferred into a die before a polymerization reaction is complete. As a result, traditional injection molding techniques do not provide proper processing when applied to these materials.

Reaction injection molding is a processing technique used specifically for certain reactive thermosetting plastics. By “reactive” it is meant that the polymer is formed from two or more components which react. Generally, the components, prior to reacting, exhibit relatively low viscosities. The low viscosities of the components allow the use of lower temperatures and pressures than those utilized in traditional injection molding. In reaction injection molding, the two or more components are combined and react to produce the final polymerized material. Mixing of these separate components is critical, a distinct difference from traditional injection molding.

Accordingly, there is a need for a new mold or die configuration and a new method of processing for reaction injection molding a golf ball cover or inner layer which promotes increased mixing of constituent materials, resulting in enhanced properties and the ability to explore the use of materials new to the golf ball art.

The process of reaction injection molding a golf ball cover or other component or layer, involves placing a golf ball core into a die, closing the die, injecting the reactive components into a mixing chamber or other molding cavity where they combine, and if not already in the molding chamber, transferring the combined material into the die or mold. The mixing begins the polymerization reaction which is typically completed upon cooling of the cover material.

Golf ball molding dies generally meet along an interface, which is typically flat or planar. This interface is often referred to as a “parting line” since when the molds are viewed from an external side view, the interface appears as a line. The parting line is the region at which the molds separate from one another. Experience has shown that golf ball cavities in which the parting line is planar, i.e. extends within a single plane, will produce “witness lines” or sink marks on the equator of the molded ball at the areas of the gate and the vent. These defects become more pronounced as the mold temperature is increased. Molding temperature is often increased since increased mold temperatures have numerous benefits including ease of demolding and flash management. It is believed that the pronouncement of these defects is due to increased polymer orientation as the material flows over the planar, sharp edge of the cavity. The resultant heat of the mold and of the exothermic reaction will result in noticeable defects at the areas of highest orientation. This can be remedied with the use of lower mold temperatures. However, it has also been shown that low mold temperatures can result in other defects. Therefore, there exists a need for a strategy to eliminate witness lines at higher mold temperatures.

In an attempt to remedy these problems, prior artisans have described a wide array of molds that utilize a variety of parting line configurations. However, as far as is known, those efforts were all directed to either conventional compression molding or injection molding of golf ball layers. Reaction injection molding enables the use of relatively low viscosity reactants, which can often readily flow adversely into, or at least along, part lines and thus produce further unwanted mold defects. Moreover, with the advent of the use of higher temperatures in reaction injection molding processes, this problem is often amplified in frequency and/or magnitude. Accordingly, there remains a need for an improved reaction injection molding assembly that avoids the problems associated with the formation of witness lines and other mold defects stemming from the use of relatively low viscosity reactants and high temperatures.

### BRIEF SUMMARY OF THE INVENTION

Disclosed herein, in various embodiments, are new die configurations, molding assemblies and processes for use in reaction injection molding of golf ball layers or components.

In one aspect, the exemplary embodiment provides a molding assembly adapted for reaction injection molding of a golf ball or component thereof. The molding assembly comprises a first mold defining a first molding surface and a first lip region extending around the periphery of the first molding surface. The molding assembly also comprises a second mold defining a second molding surface and a second lip region extending around the periphery of the second molding surface. The first mold and the second mold engage each other such that the first molding surface and the second molding surface define a molding chamber sized to accommodate a golf ball. The first mold and the second mold define a non-planar parting line configuration having (i) a mold parting line, and (ii) a lip parting line. The mold parting line includes at least one of a linear segment and an arcuate segment. The lip parting line includes at least two segments, each of which includes at least one of a linear segment and an arcuate segment.

In another aspect, the exemplary embodiment provides a molding assembly adapted for reaction injection molding, a golf ball or component thereof. The molding assembly comprises a first mold defining a first molding surface and a first lip region extending around the periphery of the first molding surface. The molding assembly also comprises a second mold defining a second molding surface and a second lip region extending around the periphery of the second molding surface. The first mold and the second mold engage each other such that the first molding surface and the second molding surface define a molding chamber. The first mold and the second mold define a non-planar parting line configuration having (i) a mold parting line, and (ii) a lip parting line including two segments. Each lip parting line segment extends along a line of symmetry. The mold parting line includes at least one of a linear segment and an arcuate segment. And, the line of symmetry for each of the lip parting line segments is linear or arcuate.

In an additional aspect, the exemplary embodiment provides a molding assembly adapted for reaction injection molding a golf ball or component thereof. The molding assembly comprising a first mold defining a first molding surface and a first lip region extending around the periphery of the first molding surface. The molding assembly also comprises a second mold defining a second molding surface and a second lip region extending around the periphery of the second molding surface. The first mold and the second mold engage each other such that the first molding surface and the second molding surface define a molding chamber. The first mold and the second mold define a non-planar parting line configuration having (i) a mold parting line extending along a first line of symmetry, and (ii) a lip parting line including two segments, each segment extending along at least another line of symmetry. The first line of symmetry of the mold parting line is linear or arcuate. And, the at least another line of symmetry of the lip parting line segments is linear or arcuate.

In yet another aspect according to the exemplary embodiment, a molding assembly adapted for reaction injection molding a golf ball or component thereof is provided. The molding assembly comprises a first mold defining a first molding surface and a first lip region extending around the periphery of the first molding surface. The molding assembly also comprises a second mold defining a second molding surface and a second lip region extending around the periphery of the second molding surface. The first mold and the second mold engage each other such that the first molding surface and the second molding surface define a molding chamber. The first mold and the second mold define a non-planar parting line configuration having (i) a mold parting line extending along a line of symmetry, and (ii) a lip parting line including two segments. The line of symmetry of the mold parting line is linear or arcuate. And, each of the lip parting line segments includes at least one of a linear segment and an arcuate segment.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a schematic exploded view of a molding assembly according to the present disclosure.

FIG. 2 is a schematic side elevational view illustrating a version of a molding assembly according to one of the exemplary embodiments.

FIG. 3 is a schematic side elevational view illustrating another version of a molding assembly according to one of the exemplary embodiments.

FIG. 4 is a schematic side elevational view illustrating yet another version of a molding assembly according to one of the exemplary embodiments.

FIG. 5 is a schematic side elevational view illustrating a further version of a molding assembly according to one of the exemplary embodiments.

FIG. 6 is a schematic side elevational view illustrating another version of a molding assembly according to one of the exemplary embodiments.

FIG. 7 is a schematic side elevational view illustrating yet another version of a molding assembly according to one of the exemplary embodiments.

FIG. 8 is a schematic side elevational view illustrating still another version of a molding assembly according to one of the exemplary embodiments.

FIG. 9 is a schematic side elevational view illustrating another version of a molding assembly according to one of the exemplary embodiments.

FIG. 10 is a schematic partial cross-sectional view illustrating another version of a molding assembly according to one of the exemplary embodiments.

FIG. 11 is a schematic partial cross-sectional view illustrating another version of a molding assembly according to one of the exemplary embodiments.

FIG. 12 is a schematic partial cross-sectional view illustrating another version of a molding assembly according to one of the exemplary embodiments.

FIG. 13 is a schematic partial cross-sectional view illustrating another version of a molding assembly according to one of the exemplary embodiments.

FIG. 14 is a schematic partial cross-sectional view illustrating yet another version of a molding assembly according to one of the exemplary embodiments.

FIG. 15 is a schematic partial cross-sectional view illustrating another version of a molding assembly according to one of the exemplary embodiments.

FIG. 16 is a schematic partial cross-sectional view illustrating still another version of a molding assembly according to one of the exemplary embodiments.

FIG. 17 is a schematic partial cross-sectional view illustrating another version of a molding assembly according to one of the exemplary embodiments.

FIG. 18 is a schematic partial cross-sectional view illustrating a further version of a molding assembly according to one of the exemplary embodiments.

FIG. 19 is a schematic partial cross-sectional view illustrating another version of a molding assembly according to one of the exemplary embodiments.

FIG. 20 is a schematic partial cross-sectional view illustrating still another version of a molding assembly according to one of the exemplary embodiments.

FIG. 21 is a schematic partial cross-sectional view illustrating another version of a molding assembly according to one of the exemplary embodiments.

FIG. 22 is a schematic partial cross-sectional view illustrating yet another version of a molding assembly according to one of the exemplary embodiments.

FIG. 23 is a schematic partial cross-sectional view illustrating yet another version of a molding assembly according to one of the exemplary embodiments.

FIG. 24 is a schematic partial cross-sectional view illustrating yet another version of a molding assembly according to one of the exemplary embodiments.

FIG. 25 is a schematic partial cross-sectional view illustrating a further version of a molding assembly according to one of the exemplary embodiments.

FIG. 26 is a cross-sectional view of a golf ball formed according to a reaction injection molded (RIM) process according to one of the exemplary embodiments.

FIG. 27 is a cross-sectional view of another golf ball formed according to a reaction injection molded (RIM) process according to one of the exemplary embodiments.

FIG. 28 is a cross-sectional view of a further golf ball formed according to a reaction injection molded (RIM) process according to one of the exemplary embodiments.

FIG. 29 is a process flow diagram which schematically depicts a reaction injection molding process according to one of the exemplary embodiments.

FIG. 30 schematically shows a mold for reaction injection molding a golf ball cover according to one of the exemplary embodiments.

### DETAILED DESCRIPTION OF THE INVENTION

The exemplary embodiments disclosed herein relate to molding assemblies, particularly adapted for reaction injection molding of covers and layers on golf ball cores or intermediate assemblies, that utilize non-planar parting lines between molds. The non-planar parting lines may be exhibited as non-planar mold parting lines and/or as non-planar lip parting lines. As will be understood, the term “parting line” refers to the interface configuration between two or more molds that close to form a molding cavity or chamber. As described herein, there are two aspects of parting lines. “Mold parting lines” as used herein refers to the interface configuration between molds, such as may be evident along the exterior of the molds. And, “lip parting lines” as used herein refers to the interface configuration between regions of corresponding molds immediately adjacent to the molding cavities defined in the molds, and so, is typically not evident from the exterior of the molds. The lip parting line is made with reference to a cross section of the engaged molds. Both mold parting lines and lip parting lines extend along lines of symmetry, designated herein as S_{M} and S_{L}, respectively. The lines of symmetry can be considered as axes, or lines defining an average direction in which the parting lines extend. These lines of symmetry S_{M} and S_{L} can be co-extensive, partially or entirely, or be independent of one another. These aspects are all described in greater detail herein.

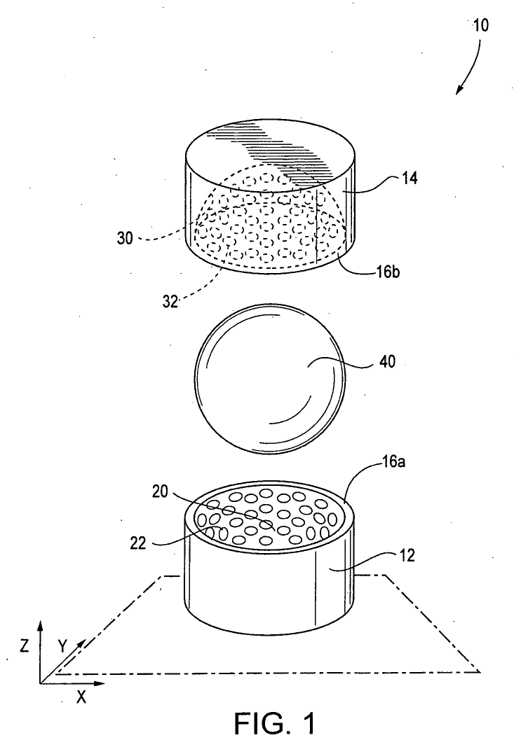

In accordance with one of the exemplary embodiments, the mold parting lines for the molding assemblies described herein are all non-planar. Furthermore, the non-planar mold parting lines may include a planar lip, as more fully described herein, or a non-planar lip configuration. The line of symmetry S_{M} for the non-planar mold parting lines may be linear, such as along an X-Y plane of the assembly as depicted in FIG. 1, or linear and extend at an angle with respect to the X-Y plane. Moreover, the line of symmetry S_{M} may also be non-linear and for example, be arcuate. The shape of the mold part line may also vary. When viewed along an elevational or side view, the mold parting line may be in the form of a series of linear segments, or be arcuate or include a series of arcuate segments. Alternately, the mold parting line can include a combination of linear and arcuate segments.

In accordance with the exemplary embodiments, the lip parting lines for the molding assemblies described herein can be in a non-planar form, or a planar form so long as the mold parting line is non-planar. The lip parting line, as depicted herein, is generally in the form of two segments when viewing a cross section of the molds. The line of symmetry S_{L} for the lip parting line, or rather for each segment, can be common or coextensive for each segment. Alternately, the line of symmetry S_{L} for each lip parting line segment can be separate from one another. When separate, each line of symmetry for each lip parting line segment can be parallel to one another or non-parallel such as angled to one another. The shape of the lip parting line or line segments, may also vary. When viewed along an elevational or side view, the lip parting line may be in the form of linear segments, be arcuate or include arcuate segments, or include a combination of linear and arcuate segments. All of these aspects are described in detail with reference to the figures.

Polyurethane and/or polyurea polymers are typically made from three reactants: alcohols, amines, and isocyanate-containing compounds. Both alcohols and amines have a reactive hydrogen atom and are generally referred to as “polyols”. They react with the isocyanate-containing compound, which is generally referred to as an “isocyanate.”

Several chemical reactions may occur during polymerization of isocyanate and polyol. Isocyanate groups (—N═C═O) that react with alcohols form a polyurethane, whereas isocyanate groups that react with an amine group form a polyurea. A polyurethane itself may react with an isocyanate to form an allophanate and a polyurea can react with an isocyanate to form a biuret. Because the biuret and allophanate reactions occur on an already-substituted nitrogen atom of the polyurethane or polyurea, these reactions increase cross-linking within the polymer.

Polyurethanes/polyureas are polymers which are used to form a broad range of products. They are generally formed by mixing two primary ingredients during processing. For the most commonly used polyurethanes, the two primary ingredients are a polyisocyanate (for example, diphenylmethane diisocyanate monomer (MDI) and toluene diisocyanate (TDI) and their derivatives) and a polyol (for example, a polyester polyol or a polyether polyol).

A wide range of combinations of polyisocyanates and polyols, as well as other ingredients, are available. Furthermore, the end-use properties of polyurethanes can be controlled by the type of polyurethane utilized, i.e., whether the material is thermoset (cross linked molecular structure) or thermoplastic (linear molecular structure).

The polyol component typically contains additives, such as stabilizers, flow modifiers, catalysts, combustion modifiers, blowing agents, fillers, pigments, optical brighteners, and release agents to modify physical characteristics of the cover. Furthermore, the polyol component may contain surfactants or other additives which promote better mixing of the two components. Polyurethane/polyurea constituent molecules that were derived from recycled polyurethane can be added in the polyol component.

Cross linking occurs between the isocyanate groups (—NCO) and the polyol's hydroxyl end-groups (—OH). Additionally, the end-use characteristics of polyurethanes can also be controlled by different types of reactive chemicals and processing parameters. For example, catalysts are utilized to control polymerization rates. Depending upon the processing method, reaction rates can be very quick (as in the case for some reaction injection molding systems (i.e., RIM) or may be on the order of several hours or longer (as in several coating systems). Consequently, a great variety of polyurethanes are suitable for different end-users.

Polyurethanes/polyureas are typically classified as thermosetting or thermoplastic. A polyurethane becomes irreversibly set when a polyurethane prepolymer is cross-linked with a polyfunctional curing agent, such as a polyamine or a polyol. The prepolymer typically is made from polyether or polyester. Diisocyanate polyethers are preferred because of their water resistance.

The physical properties of thermoset polyurethanes are controlled substantially by the degree of cross linking. Tightly cross linked polyurethanes/polyureas are fairly rigid and strong. A lower amount of cross linking results in materials that are flexible and resilient. Thermoplastic polyurethanes have some cross linking, but primarily by physical means. The crosslinkings bonds can be reversibly broken by increasing temperature, as occurs during molding or extrusion. In this regard, thermoplastic polyurethanes can be injection molded, and extruded as sheet and blow film. They can be used up to about 350° F. and are available in a wide range of hardnesses.

Polyurethane materials suitable for the exemplary embodiments are formed by the reaction of a polyisocyanate, a polyol, and optionally one or more chain extenders. The polyol component includes any suitable polyether- or polyesterpolyol. Additionally, in an alternative embodiment, the polyol component comprises polybutadiene diol. The chain extenders include, but are not limited, to diols, triols and amine extenders. Any suitable polyisocyanate may be used to form a polyurethane according to the exemplary embodiment. The polyisocyanate is preferably selected from the group of diisocyanates including, but not limited, to 4,4N-diphenylmethane diisocyanate (“MDI”); 2,4-toluene diisocyanate (“TDI”); m-xylylene diisocyanate (“XDI”); methylene bis-(4-cyclohexyl isocyanate) (“HMDI”); hexamthylene diisocyanate (HDI); naphthalene-1,5,-diisocyanate (“NDI”); 3,3N-dimethyl-4,4N-biphenyl diisocyanate (“TODI”); 1,4-diisocyanate benzene (“PPDI”); phenylene- 1,4-diisocyanate; and 2,2,4- or 2,4,4-trimethyl hexamethylene diisocyanate (“TMDI”).

Other less preferred diisocyanates include, but are not limited to, isophorone diisocyanate (“IPDI”); 1,4-cyclohexyl diisocyanate (“CHDI”); diphenylether-4,4N-diisocyanate; p,pN-diphenyl diisocyanate; lysine diisocyanate (“LDI”); 1,3-bis (isocyanato methyl) cyclohexane; and polymethylene polyphenyl isocyanate (“PMDI”).

One polyurethane component which can be used in the exemplary embodiment incorporates TMXDI (META) aliphatic isocyanate (Cytec Industries, West Paterson, N.J.). Polyurethanes based on meta-tetramethylxylyliene diisocyanate can provide improved gloss retention, UV light stability, thermal stability and hydrolytic stability. Additionally, TMXDI (META) aliphatic isocyanate has demonstrated favorable toxicological properties. Furthermore, because it has a low viscosity, it is usable with a wider range of diols (to polyurethane) and diamines (to polyureas). If TMXDI is used, it typically, but not necessarily, is added as a direct replacement for some or all of the other aliphatic isocyanates in accordance with the suggestions of the supplier. Because of slow reactivity of TMXDI, it may be useful or necessary to use catalysts to have practical demolding times. Hardness, tensile strength and elongation can be adjusted by adding further materials in accordance with the supplier's instructions.

Suitable glycol chain extenders include, but are not limited to ethylene glycol; propane glycol; butane glycol; pentane glycol; hexane glycol; benzene glycol; xylenene glycol; 1,4-butane diol; 1,3-butane diol; 2,3-dimethyl-2,3-butane diol; and dipropylene glycol.

Suitable amine extenders include, but are not limited to, tetramethyl-ethylenediamine; dimethylbenzylamine; diethylbenzylamine; diethyltoluenediamine; pentamethyldiethylenetriamine; dimethyl cyclohexylamine; tetramethyl-1,3-butanediamine; 1,2-dimethylimidazole; 2-methylimidazole; pentamethyldipropylenetriamine; and bis-(dismethylaminoethylether).

Polyurethane/polyurea compositions of the exemplary embodiment are especially desirable as materials in forming golf balls. Polyurethanes/polyureas according to the exemplary embodiment, are suitable materials for any of a core layer, a mantle layer, and a cover layer. Most preferably, the polyurethane materials are used to form a cover layer. Accordingly, golf balls according to the exemplary embodiment, may be formed as two-piece, or multi-layer balls having either a wound core or a solid, non-wound core. In a preferred form, golf balls utilizing a polyurethane composition described herein are solid, i.e., non-wound, multi-layer golf balls comprising a solid non-wound core, a cover formed from the exemplary embodiment polyurethane, and one or more intermediate layers disposed between the cover and the core.

Specifically, multi-layer golf balls can be produced by injection molding or compression molding a mantle layer about wound or solid molded cores to produce an intermediate golf ball having a diameter of about 1.50 to 1.67 inches, preferably about 1.64 inches. The cover layer is subsequently molded over the mantle layer to produce a golf ball having a diameter of 1.680 inches or more. Although either solid cores or wound cores can be used in the exemplary embodiment, as a result of their lower cost and superior performance, solid molded cores are preferred over wound cores.

In compression molding, the inner cover composition is formed via injection at about 380° F. to about 450° F. into smooth surfaced hemispherical shells which are then positioned around the core in a mold having the desired inner cover thickness and subjected to compression molding at 200° to 300° F. for about 2 to 10 minutes, followed by cooling at 50° to 70° F. for about 2 to 7 minutes to fuse the shells together to form a unitary intermediate ball. In addition, the intermediate balls may be produced by injection molding wherein the inner cover layer is injected directly around the core placed at the center of an intermediate ball mold for a period of time in a mold temperature of from 50° to about 100° F. Subsequently, the outer cover layer is molded about the core and the inner layer by similar compression or injection molding techniques to form a dimpled golf ball of a diameter of 1.680 inches or more.

A preferred form of the exemplary embodiment is a golf ball in which at least one cover or core layer comprises a fast-chemical-reaction-produced component. This component includes at least one material selected from the group consisting of polyurethane, polyurea, polyurethane isomer, epoxy, and unsaturated polyesters, and preferably comprises polyurethane/polyurea. The exemplary embodiment also includes a method of producing a golf ball which contains a fast-chemical-reaction-produced component. A golf ball formed according to the exemplary embodiment preferably has a flex modulus in the range of from about 1 to about 310 kpsi, a Shore B hardness in the range of from about 10 to about 95, and good durability. As used herein, “Shore B hardness” of a cover, intermediate layer or core is measured generally in accordance with ASTM D-2240, except the measurements are made on the curved surface of a molded ball component, rather than on a plaque. Furthermore, the Shore B hardness of the cover or intermediate layer is measured while the cover remains over the core. When a hardness measurement is made on a dimpled cover, Shore B hardness is measured at a land area of the dimpled cover.

Particularly preferred forms of the exemplary embodiment also provide for a golf ball with a fast-chemical-reaction-produced cover having good scuff resistance and cut resistance.

As used herein, “polyurethane and/or polyurea” is expressed as “polyurethane/polyurea” or “polyurethane”.

A particularly preferred form of the exemplary embodiment is a golf ball with a cover comprising polyurethane/polyurea, wherein the cover includes from about 5 to about 100 weight percent of polyurethane formed from recycled polyurethane/polyurea.

The method of the exemplary embodiment is particularly useful in forming golf balls because it can be practiced at relatively low temperatures and pressures. The preferred temperature range for the preferred method of the disclosure is from about 90 to about 180° F. when the component being produced contains polyurethane/polyurea. Preferred pressures for practicing the exemplary embodiment using polyurethane-containing materials are 300 psi or less and more preferably 100 psi or less. These pressure values are in-process pressures in a fluid passage or runner during molding. The method of the exemplary embodiment offers numerous advantages over conventional slow-reactive process compression molding of golf ball covers. The method of the exemplary embodiment results in molded covers in a mold release or demold time of 10 minutes or less, preferably 2 minutes or less, and most preferably in 1 minute or less. The method of the present disclosure results in the formation of a reaction product, formed by mixing two or more reactants together, that exhibits a reaction time of about 2 minutes or less, preferably 1 minute or less, and most preferably about 30 seconds or less. An excellent finish can be produced on the ball.

The term “demold time” generally refers to the mold release time, which is the time span from the mixing of the components until the earliest possible removal of the finished part, sometimes referred to in the industry as “green strength.” The term “reaction time” generally refers to the setting time or curing time, which is the time span from the beginning of mixing until a point is reached where the polyaddition product no longer flows. Further description of the terms “setting time” and “mold release time” are provided in the “Polyurethane Handbook,” Edited by Günter Oertel, Second Edition, ISBN 1-56990-157-0, herein incorporated by reference.

The method of the disclosure is also effective when recycled polyurethane or other polymer resin, or materials derived by recycling polyurethane or other polymer resin, is incorporated into the product. The process may include the step of recycling at least a portion of the reaction product, preferably by glycolysis. 5-100% of the polyurethane/polyurea formed from the reactants used to form particular components is obtained from recycled polyurethane/polyurea.

As indicated above, the fast-chemical-reaction-produced component can be one or more cover and/or core layers of the ball. When a polyurethane cover is formed according to the disclosure, and is then covered with a polyurethane top coat, excellent adhesion can be obtained. Furthermore, an indicia may be printed or stamped onto the polyurethane top coat, onto the underlying primer, or directly onto the surface of the ball using any of the inks known to those skilled in the art. These include but are not limited to typical inks such as one component polyurethane inks and two component polyurethane inks.

The preferred method of forming a fast-chemical-reaction-produced component for a golf ball according to the disclosure is by reaction injection molding (RIM). RIM is a process by which highly reactive liquids are injected into a closed mold, mixed usually by impingement and/or mechanical mixing in an in-line device such as a “peanut mixer”, where they polymerize primarily in the mold to form a coherent, one-piece molded article. The RIM processes usually involve a rapid reaction between one or more reactive components such as polyether—or polyester—polyol, polyamine, or other material with an active hydrogen, and one or more isocyanate—containing constituents, often in the presence of a catalyst. The constituents are stored in separate tanks prior to molding and may be first mixed in a mix head upstream of a mold and then injected into the mold. The liquid streams are metered in the desired weight to weight ratio and fed into an impingement mix head, with mixing occurring under high pressure, e.g., 1500 to 3000 psi. The liquid streams impinge upon each other in the mixing chamber of the mix head and the mixture is injected into the mold. One of the liquid streams typically contains a catalyst for the reaction. The constituents react rapidly after mixing to gel and form polyurethane polymers. Polyureas, epoxies, and various unsaturated polyesters also can be molded by RIM.

RIM differs from non-reaction injection molding in a number of ways. The main distinction is that in RIM a chemical reaction takes place in the mold to transform a monomer or adducts to polymers and the components are in liquid form. Thus, a RIM mold need not be made to withstand the pressures which occur in a conventional injection molding. In contrast, injection molding is conducted at high molding pressures in the mold cavity by melting a solid resin and conveying it into a mold, with the molten resin often being at about 150 to about 350° C. At this elevated temperature, the viscosity of the molten resin usually is in the range of 50,000 to about 1,000,000 centipoise, and is typically around 200,000 centipoise. In an injection molding process, the solidification of the resins occurs after about 10 to about 90 seconds, depending upon the size of the molded product, the temperature and heat transfer conditions, and the hardness of the injection molded material. Subsequently, the molded product is removed from the mold. There is no significant chemical reaction taking place in an injection molding process when the thermoplastic resin is introduced into the mold. In contrast, in a RIM process, the chemical reaction causes the material to set, typically in less than about 5 minutes, often in less than 2 minutes, preferably less than 1 minute, more preferably in less than 30 seconds, and in many cases in about 10 seconds or less.

If plastic products are produced by combining components that are preformed to some extent, subsequent failure can occur at a location on the cover which is along the seam or parting line of the mold. Failure can occur at this location because this interfacial region is intrinsically different from the remainder of the cover layer and can be weaker or more stressed. The present disclosure is believed to provide for improved durability of a golf ball cover layer by providing a uniform or “seamless” cover in which the properties of the cover material in the region along the parting line are generally the same as the properties of the cover material at other locations on the cover, including at the poles. The improvement in durability is believed to be a result of the fact that the reaction mixture is distributed uniformly into a closed mold. This uniform distribution of the injected materials eliminates knit-lines and other molding deficiencies which can be caused by temperature difference and/or reaction difference in the injected materials. The process of the disclosure results in generally uniform molecular structure, density and stress distribution as compared to conventional injection-molding processes.

The fast-chemical-reaction-produced component has a flex modulus of 1 to 310 kpsi, more preferably 5 to 100 kpsi, and most preferably 5 to 80 kpsi. The subject component can be a cover with a flex modulus which is higher than that of the centermost component of the cores, as in a liquid center core and some solid center cores. Furthermore, the fast-chemical-reaction-produced component can be a cover with a flex modulus that is higher than that of the immediately underlying layer, as in the case of a wound core. The core can be one piece or multi-layer, each layer can be either foamed or unfoamed, and density adjusting fillers, including metals, can be used. The cover of the ball can be harder or softer than any particular core layer.

The fast-chemical-reaction-produced component can incorporate suitable additives and/or fillers. When the component is an outer cover layer, pigments or dyes, accelerators and UV stabilizers can be added. Examples of suitable optical brighteners which probably can be used include Uvitex and Eastobrite OB-1. An example of a suitable white pigment is titanium dioxide. Examples of suitable and UV light stabilizers are provided in commonly assigned U.S. Pat. No. 5,494,291. Fillers which can be incorporated into the fast-chemical-reaction-produced cover or core component include those listed herein. Furthermore, compatible polymeric materials can be added. For example, when the component comprises polyurethane and/or polyurea, such polymeric materials include polyurethane ionomers, polyamides, etc. A golf ball core layer formed from a fast-chemical-reaction-produced material according to the present disclosure typically contains 0 to 20 weight percent of such filler material, and more preferably 1 to 15 weight percent. When the fast-chemical-reaction-produced component is a core, the additives typically are selected to control the density, hardness and/or coefficient of restitution (COR).

A golf ball inner cover layer or mantle layer formed from a fast-chemical-reaction-produced material according to the exemplary embodiment typically contains 0 to 60 weight percent of filler material, more preferably 1 to 30 weight percent, and most preferably 1 to 20 weight percent.

A golf ball outer cover layer formed from a fast-chemical-reaction-produced material according to the exemplary embodiment typically contains 0 to 20 weight percent of filler material, more preferably 1 to 10 weight percent, and most preferably 1 to 5 weight percent.

Catalysts can be added to the RIM polyurethane system starting materials as long as the catalysts generally do not react with the constituent with which they are combined. Suitable catalysts include those which are known to be useful with polyurethanes and polyureas.

The reaction mixture viscosity should be sufficiently low to ensure that the empty space in the mold is completely filled. The reactant materials generally are preheated to 90 to 165° F. before they are mixed. In most cases it is necessary to preheat the mold to, e.g., 100 to 180° F., to ensure proper injection viscosity.

As indicated above, one or more cover layers of a golf ball can be formed from a fast-chemical-reaction-produced material according to the exemplary embodiment.

Referring now to the drawings, FIG. 1 illustrates a partially exploded perspective view of an exemplary embodiment molding assembly and positioning of a golf ball core or intermediate golf ball assembly between two molding components of the assembly. Specifically, FIG. 1 illustrates a molding assembly 10 comprising a first or bottom mold 12 and a corresponding second or top mold 14. The first or bottom mold 12 defines a hemispherical molding surface 20 which defines a plurality of dimple projections 22. Similarly, the second or top mold 14 defines a hemispherical molding surface 30 which defines a plurality of dimple projections 32. The first or bottom mold 12 defines a mating interface or region of engagement 16a at which the second or top mold 14, also having a region of mating or engagement shown as 16b, contact each other. For the descriptions provided herein, reference is often made to directions of line segments or orientation of planes. Such descriptions are made with reference to the X-Y-Z coordinate system depicted in FIG. 1. In forming a cover or other layer, a golf ball core 40 is positioned between the molds 12 and 14 and upon closing the molds, the core 40 is positioned within the molding cavity formed by the molding surfaces 20 and 30. The molds are generally closed or opened with respect to each other by moving one or both along the Z-axis.

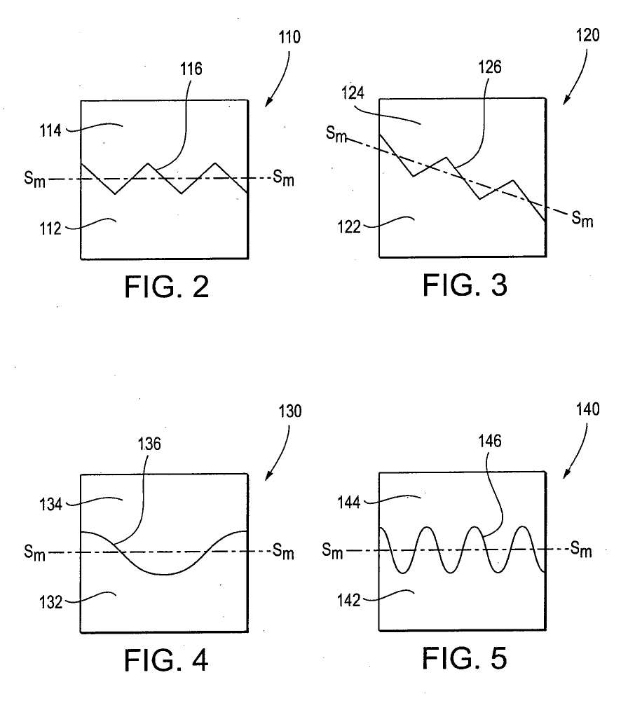

FIG. 2 illustrates a molding assembly 110 according to one of the exemplary embodiments. The assembly 110 comprises a first or bottom mold 112, and a second or top mold 114, that mate or otherwise engage along a non-planar mold parting line 116. The mold parting line 116 is shown as having a zigzag shape and extends along a line of symmetry S_{M} as shown. In this embodiment, the line of symmetry S_{M} of mold parting line 116 generally extends within or parallel to the X-Y plane associated with the molds as depicted in FIG. 1. The mold parting line 116 includes a plurality of linear segments, each oriented at an angle with respect to each other.

FIG. 3 illustrates a molding assembly 120 according to another exemplary embodiment. The assembly 120 comprises a first or a bottom mold 122, and a second or top mold 124, that mate or otherwise engage along a non-planar mold parting line 126. The mold parting line is zigzag in shape and extends along a line of symmetry S_{M} as shown. In this embodiment, the line of symmetry S_{M} of the mold parting line 126 extends at angle with respect to the X-Y plane of the molds. The mold parting line 126 includes a plurality of linear segments, each oriented at an angle with respect to each other.

FIG. 4 illustrates a molding assembly 130 according to a further exemplary embodiment. The assembly 130 comprises a first or a bottom mold 132, and a second or top mold 134, that mate or otherwise engage along a non-planar parting line 136. The mold parting line 136 is arcuate in shape and extends along a line of symmetry S_{M} as shown. The line of symmetry of the mold parting line 136 is parallel to the X-Y plane of the molds.

FIG. 5 illustrates a molding assembly 140 according to another one of the exemplary embodiments. The assembly 140 comprises a first or a bottom mold 142, and a second or top mold 144 , that mate or otherwise engage along a non-planar mold parting line 146. The mold parting line is generally arcuate in shape and extends along a line of symmetry S_{M} as shown. In this embodiment, the line of symmetry of the mold parting line 146 is parallel to the X-Y plane associated with the molds, however, the frequency of the arcuate “humps” is greater than the embodiment depicted in FIG. 4.

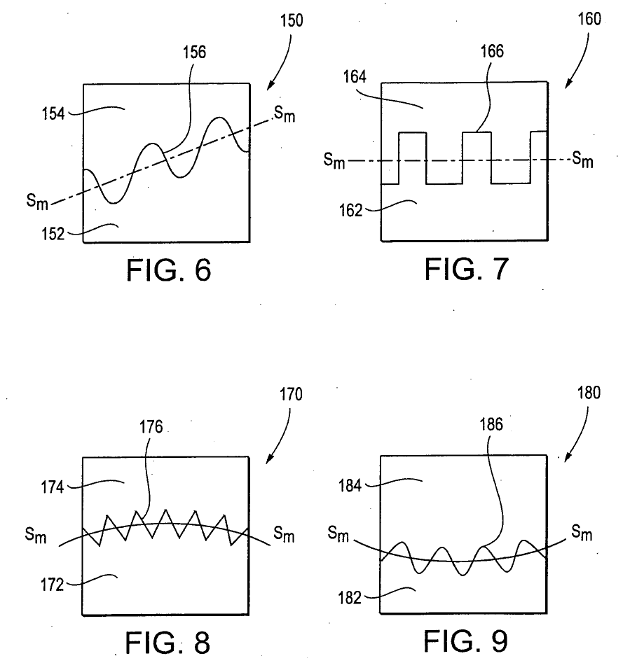

FIG. 6 illustrates a molding assembly 150 according to an additional exemplary embodiment. The assembly 150 comprises a first or a bottom mold 152, and a second or top mold 154, that mate or otherwise engage along a non-planar mold parting line 156. The mold parting line 156 is arcuate in shape and extends along a line of symmetry S_{M} as shown. The line of symmetry S_{M} of the mold parting line 156 extends at an angle with respect to the X-Y plane associated with the molds.

FIG. 7 illustrates a molding assembly 160 according to a further exemplary embodiment. The assembly 160 comprises a first or a bottom mold 162, and a second or top mold 164, that mate or otherwise engage along a non-planar parting line 166. The mold parting line includes a series of linear segments in a step configuration. The mold parting line 166 extends along a line of symmetry S_{M} as shown. The line of symmetry S_{M} of the mold parting line 166 extends parallel to the X-Y plane. The mold parting line 166 includes a series of linear segments, each oriented at right angles.

FIG. 8 illustrates a molding assembly 170 according to still another exemplary embodiment. The assembly 170 comprises a first or a bottom mold 172, and a second or top mold 174, that mate or otherwise engage along a non-planar parting line 176. The mold parting line 176 is zigzag in shape and extends along a line of symmetry S_{M} as shown. In this embodiment, the line of symmetry S_{M} of the mold parting line 176 is arcuate. The mold parting line 176 includes a plurality of linear segments oriented at some angle with respect to each other.

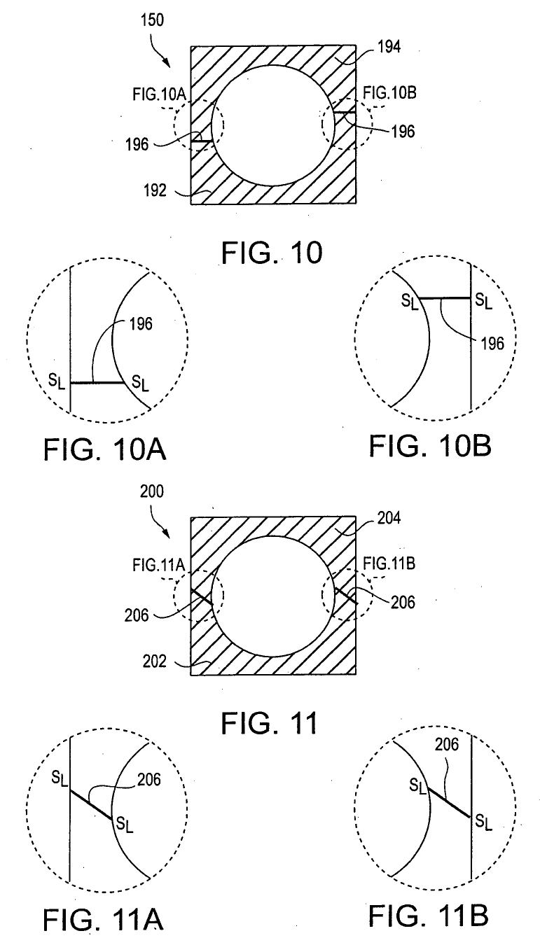

FIG. 9 illustrates a molding assembly 180 according to a still further exemplary embodiment. The assembly 180 comprises a first or a bottom mold 182, and a second or top mold 184, that mate or otherwise engage along a non-planar parting line 186. The mold parting line 186 is arcuate in shape and extends along a line of symmetry S_{M} as shown. The line of symmetry S_{M} of the mold parting line 186 is arcuate. The mold parting line 186 includes a series of arcuate segments.

FIG. 10 illustrates a schematic cross-sectional view of a molding assembly 190 according to another exemplary embodiment. The assembly 190 comprises a first or bottom mold 192, and a second or top mold 194, that mate or otherwise engage along a lip parting line 196. The lip parting line may extend along the molds 192, 194 as depicted in any of FIGS. 2-9 or as otherwise described herein. The lip parting line 196 is linear, and extends along a line of symmetry S_{L} as shown in FIGS. 10A and 10B. The lines of symmetry S_{L} of each segment of the lip parting line 196 are parallel to the X-Y plane associated with the molds. Each segment of S_{L} is parallel with each other, however extending in different planes.

FIG. 11 illustrates a schematic cross-sectional view of a molding assembly 200 according to one of the exemplary embodiments. The assembly 200 comprises a first or bottom mold 202, and a second or top mold 204, that mate or otherwise engage along a lip parting line 206. The lip parting line may extend along the molds 202, 204 as depicted in any of FIGS. 2-9 or as otherwise described herein. The lip parting line 206 is generally linear, and extends along a line of symmetry S_{L} as shown. The lines of symmetry S_{L} of each segment of the lip parting line 206 extends at an angle with respect to the X-Y plane of the molds. Each segment of S_{L} is parallel with each other.

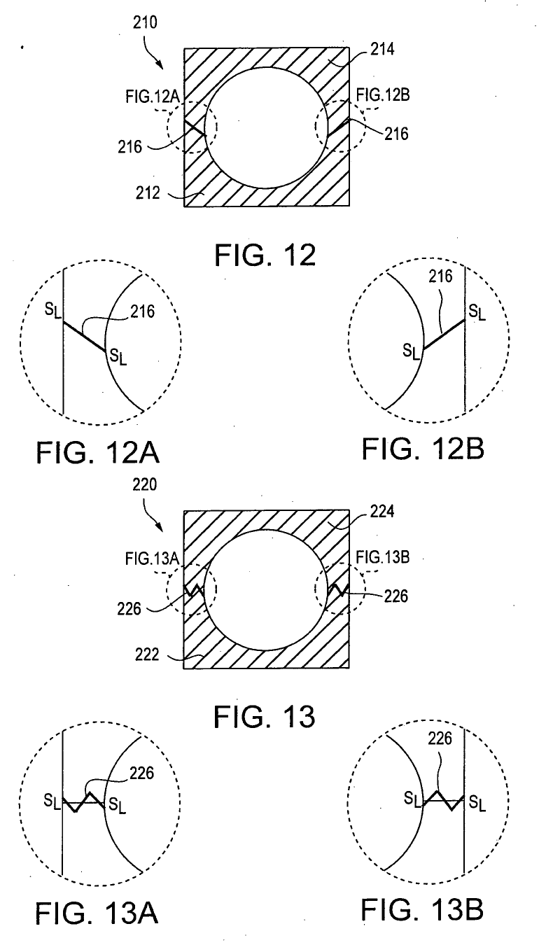

FIG. 12 illustrates a schematic cross-sectional view of a molding assembly 210 according to an additional exemplary embodiment. The assembly 210 comprises a first or bottom mold 212, and a second or top mold 214, that mate or otherwise engage along a lip parting line 216. The lip parting line may extend along the molds 212, 214 as depicted in any of FIGS. 2-9 or as otherwise described herein. The lip parting line 216 is generally linear, and extends along a line of symmetry S_{L} as shown. The lines of symmetry S_{L} of each segment of the lip parting line 216 extends at an angle with respect to the X-Y plane of the molds. The segments of the line 216 extend at an angle with respect to each other and so, are not parallel.

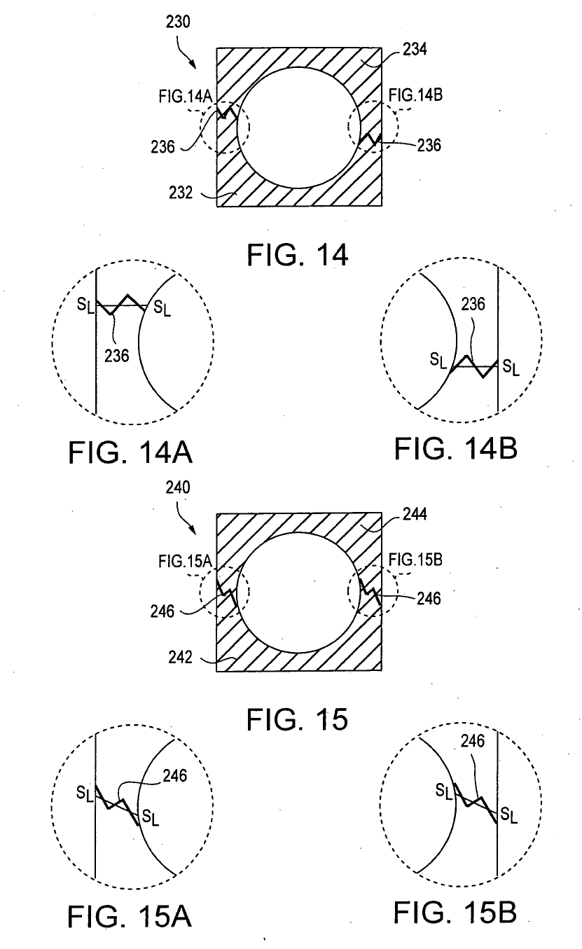

FIG. 13 illustrates a schematic cross-sectional view of a molding assembly 220 according to a further exemplary embodiment. The assembly 220 comprises a first or bottom mold 222, and a second or top mold 224, that mate or otherwise engage along a lip parting line 226. The lip parting line may extend along the molds 222, 224 as depicted in any of FIGS. 2-9 or as otherwise described herein. The lip parting line 226 is generally zigzag in shape, and extends along a line of symmetry S_{L} as shown. The line of symmetry S_{L} of the lip parting line 226 is parallel to the X-Y plane of the molds. And each segment of the line of symmetry S_{L} of the line 226 extends within the same plane. The lip parting line 226 includes a series of linear segments, each oriented at an angle with respect to adjacent line segments of the line 226.

FIG. 14 illustrates a schematic cross-sectional view of a molding assembly 230 according to another of the exemplary embodiments. The assembly 230 comprises a first or bottom mold 232, and a second or top mold 234, that mate or otherwise engage along a lip parting line 236. The lip parting line may extend along the molds 232, 234 as depicted in any of FIGS. 2-9 or as otherwise described herein. The lip parting line 236 is zigzag in shape, and extends along a line of symmetry S_{L} as shown. The lines of symmetry S_{L} of each segment of the line 236 are parallel to the X-Y plane of the molds but extend within different planes. The lip parting line 236 includes a plurality of linear segments, oriented at an angle to adjacent segments.

FIG. 15 illustrates a schematic cross-sectional view of a molding assembly 240 according to one of the exemplary embodiments. The assembly 240 comprises a first or bottom mold 242, and a second or top mold 244, that mate or otherwise engage along a lip parting line 246. The lip parting line may extend along the molds 242, 244 as depicted in any of FIGS. 2-9 or as otherwise described herein. The lip parting line 246 is generally zigzag in shape, and extends along a line of symmetry S_{L} as shown. The lines of symmetry S_{L} of each segment of the lip parting line 246 extend at an angle with respect to the X-Y plane of the molds and are parallel to each other. The segments of the line 246 are oriented at an angle with respect to each other.

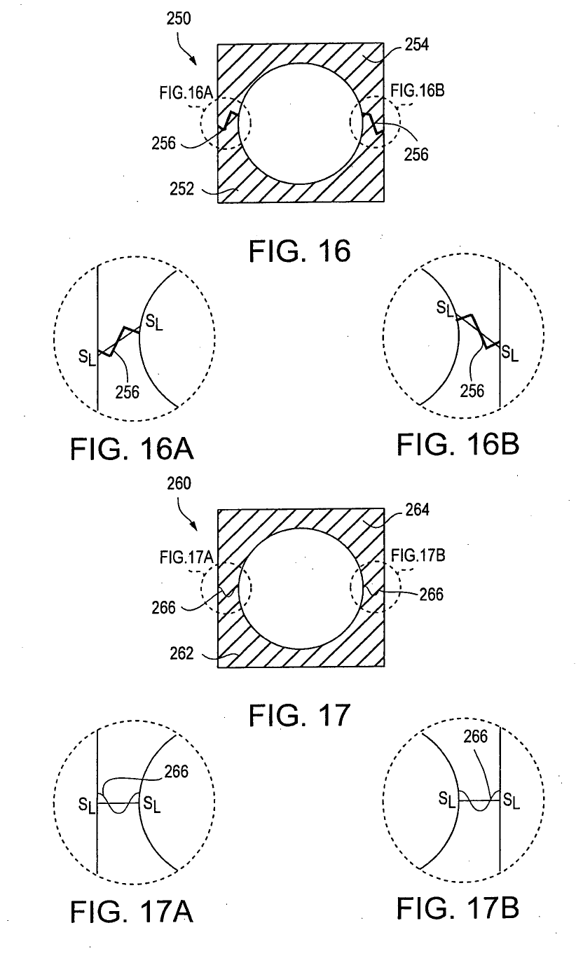

FIG. 16 illustrates a schematic cross-sectional view of a molding assembly 250 according to a further exemplary embodiment. The assembly 250 comprises a first or bottom mold 252, and a second or top mold 254, that mate or otherwise engage along a lip parting line 256. The lip parting line may extend along the molds 252, 254 as depicted in any of FIGS. 2-9 or as otherwise described herein. The lip parting line 256 is generally zigzag in shape, and extends along a line of symmetry S_{L} as shown. The lines of symmetry S_{L} of each segment of the lip parting line 256 extend at an angle with respect to the X-Y plane of the molds. The segments of the lip parting line 256 also extend at an angle with respect to each other, and so, are not parallel. The segments of the line 256 are oriented at an angle with respect to each other.

FIG. 17 illustrates a schematic cross-sectional view of a molding assembly 260 according to another of the exemplary embodiments. The assembly 260 comprises a first or bottom mold 262, and a second or top mold 264, that mate or otherwise engage along a lip parting line 266. The lip parting line may extend along the molds 262, 264 as depicted in any of FIGS. 2-9 or as otherwise described herein. The lip parting line 266 is arcuate in shape, and extends along a line of symmetry S_{L} as shown. The lines of symmetry S_{L} of each segment of the lip parting line 266 extend within the same plane, and are parallel with the X-Y plane associated with the molds.

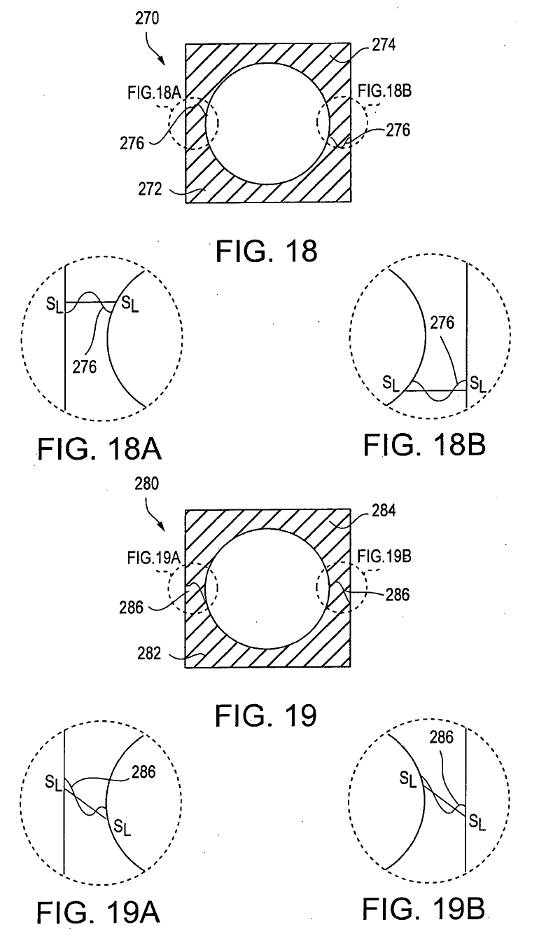

FIG. 18 illustrates a schematic cross-sectional view of a molding assembly 270 according to an additional exemplary embodiment. The assembly 270 comprises a first or bottom mold 272, and a second or top mold 274, that mate or otherwise engage along a lip parting line 276. The lip parting line may extend along the molds 272, 274 as depicted in any of FIGS. 2-9 or as otherwise described herein. The lip parting line 276 is arcuate in shape, and extends along a line of symmetry S1 as shown. The lines of symmetry S_{L} of each segment of the lip parting line 276 are parallel to one another, parallel with the X-Y plane associated with the molds, and extend within different planes.

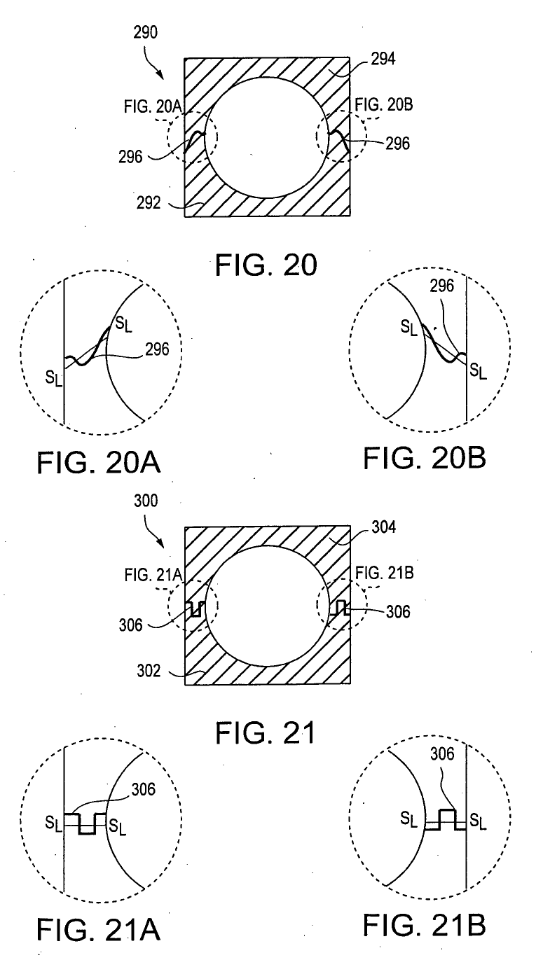

FIG. 19 illustrates a schematic cross-sectional view of a molding assembly 280 according to a further exemplary embodiment. The assembly 280 comprises a first or bottom mold 282, and a second or top mold 284, that mate or otherwise engage along a lip parting line 286. The lip parting line may extend along the molds 282, 284 as depicted in any of FIGS. 2-9 or as otherwise described herein. The lip parting line 286 is arcuate in shape, and extends along a line of symmetry S1 as shown. The lines of symmetry S_{L} of each segment of the lip parting line 286 are parallel to one another and extend within different planes. These segments extend at some angle to the X-Y plane of the molds.

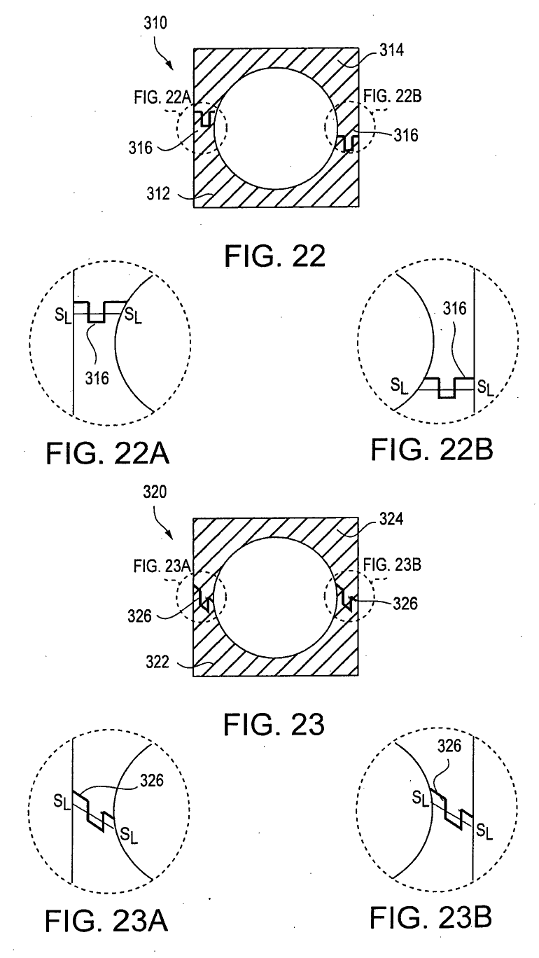

FIG. 20 illustrates a schematic cross-sectional view of a molding assembly 290 according to one of the exemplary embodiments. The assembly 290 comprises a first or bottom mold 292, and a second or top mold 294, that mate or otherwise engage along a lip parting line 296. The lip parting line may extend along the molds 292, 294 as depicted in any of FIGS. 2-9 or as otherwise described herein. The lip parting line, 296 is arcuate in shape, and extends along a line of symmetry S_{L} as shown. The lines of symmetry S_{L} of each segment of the lip parting line 296 are oriented at an angle with respect to each other. These segments also extend at some angle with respect to the X-Y plane of the molds.

FIG. 21 illustrates a schematic cross-sectional view of a molding assembly 300 according to a further exemplary embodiment. The assembly 300 comprises a first or bottom mold 302, and a second or top mold 304, that mate or otherwise engage along a lip parting line 306. The lip parting line may extend along the molds 302, 304 as depicted in any of FIGS. 2-9 or as otherwise described herein. The lip parting line 306 generally includes a series of linear line segments arranged in a step shape, and extends along a line of symmetry S1 as shown. The lines of symmetry S_{L} of each segment of the lip parting line 306 extend within the same plane and are parallel to the X-Y plane of the molds.

FIG. 22 illustrates a schematic cross-sectional view of a molding assembly 310 according to another exemplary embodiment. The assembly 310 comprises a first or bottom mold 312, and a second or top mold 314, that mate or otherwise engage along a lip parting line 316. The lip parting line may extend along the molds 312, 314 as depicted in any of FIGS. 2-9 or as otherwise described herein. The lip parting line 316 generally includes a series of linear segments, shown as a step pattern and extends along a line of symmetry S_{L} as shown. The lines of symmetry S_{L} of each segment of the lip parting line 316 extend within different planes and are parallel with each other, and the X-Y plane associated with the molds.

FIG. 23 illustrates a schematic cross-sectional view of a molding assembly 320 according to a still further exemplary embodiment. The assembly 320 comprises a first or bottom mold 322, and a second or top mold 324, that mate or otherwise engage along a lip parting line 326. The lip parting line may extend along the molds 322, 324 as depicted in any of FIGS. 2-9 or as otherwise described herein. The lip parting line 326 generally includes a series of line segments, shown as a step pattern and extends along a line of symmetry S_{L} as shown. The lines of symmetry S_{L} of each segment of the lip parting line 326 extend in different planes, but are parallel to one another. The lines of symmetry S_{L} of each segment of the lip parting line 326 extend at an angle with respect to the X-Y plane associated with the molds.

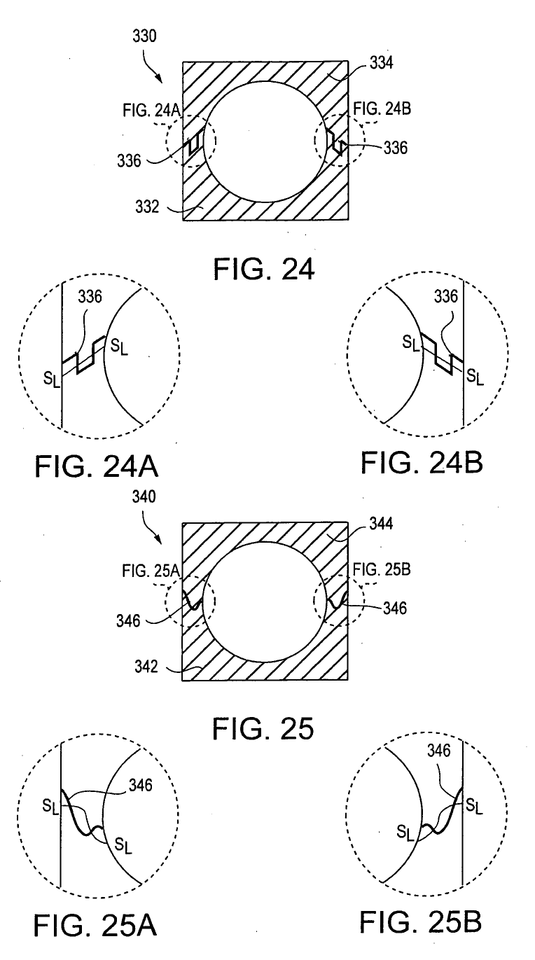

FIG. 24 illustrates a schematic cross-sectional view of a molding assembly 330 according to an additional exemplary embodiment. The assembly 330 comprises a first or bottom mold 330, and a second or top mold 334, that mate or otherwise engage along a lip parting line 336. The lip parting line 336 may extend along the molds 332, 334 as depicted in any of FIGS. 2-9 or as otherwise described herein. The lip parting line 336 generally includes a series of linear segments arranged in a step shape, and extends along a line of symmetry S_{L} as shown. The lines of symmetry S_{L} of each segment of the lip parting line 336 extend at an angle with respect to each other and are not parallel, nor parallel with the X-Y plane of the molds.

FIG. 25 illustrates a schematic cross-sectional view of a molding assembly 340 according to another exemplary embodiment. The assembly 340 comprises a first or bottom mold 342, and a second or top mold 344, that mate or otherwise engage along a lip parting line 346. The lip parting line 346 may extend along the molds 342, 344 as depicted in any of FIGS. 2-9 or as otherwise described herein. The lip parting line 346 is generally arcuate in shape, and extends along a line of symmetry S_{L} as shown. In this embodiment, the line of symmetry S_{L} of each segment of the lip parting line 346, is arcuate.

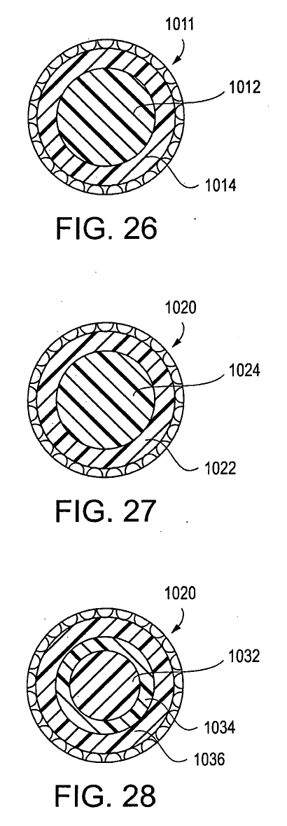

Referring to FIG. 26, a golf ball having a cover comprising a RIM polyurethane is shown. The golf ball 1010 includes a polybutadiene core 1012 and a polyurethane cover 1014 formed by RIM using an exemplary embodiment molding assembly.

Referring now to FIG. 27, a golf ball having a core comprising a RIM polyurethane is shown. The golf ball 1020 has a RIM polyurethane core 1022, and a RIM polyurethane cover 1024. The ball was formed using an exemplary embodiment molding assembly.

Referring to FIG. 28, a multi-layer golf ball 1030 is shown with a solid core 1032 containing recycled RIM polyurethane, a mantle cover layer 1034 comprising RIM polyurethane, and an outer cover layer 1036 comprising isomer or another conventional golf ball cover material. Such conventional golf ball cover materials typically contain titanium dioxide utilized to make the cover white in appearance. Non-limiting examples of multi-layer golf balls according to the exemplary embodiment with two cover layers include those with RIM polyurethane mantles having a thickness of from about 0.01 to about 0.20 inches and a Shore D hardness of 10 to 95, covered with ionomeric or non-ionomeric thermoplastic, balata or other covers having a Shore D hardness of from about 10 to about 95 and a thickness of 0.020 to 0.20 inches.

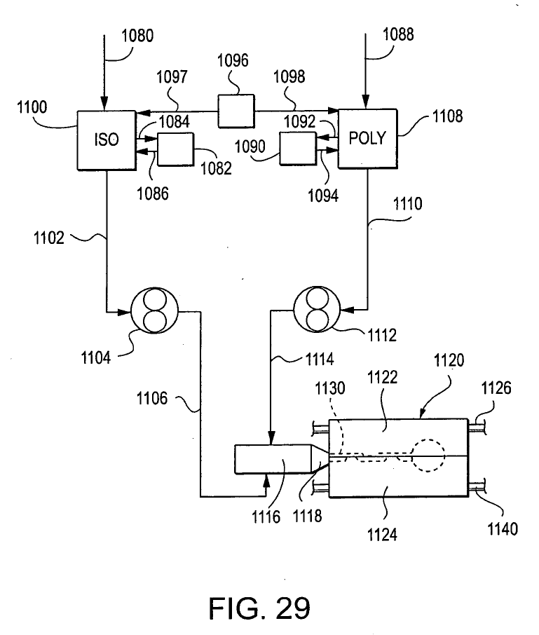

Referring next to FIG. 29, a process flow diagram for forming a RIM cover of polyurethane is shown. Isocyanate from bulk storage is fed through line 1080 to an isocyanate tank 1100. The isocyanate is heated to the desired temperature, e.g. 90 to about 150° F., by circulating it through heat exchanger 1082 via lines 1084 and 1086. Polyol, polyamine, or another compound with an active hydrogen atom is conveyed from bulk storage to a polyol tank 1108 via line 1188. The polyol is heated to the desired temperature, e.g. 90 to about 150° F., by circulating it through heat exchanger 1090 via lines 1092 and 1094. Dry nitrogen gas is fed from nitrogen tank 1096 to isocyanate tank 1100 via line 1097 and to polyol tank 1108 via line 1088. Isocyanate is fed from isocyanate tank 1100 via line 1102 through a metering cylinder or metering pump 1104 into recirculation mix head inlet line 1106. Polyol is fed from polyol tank 1108 via line 1110 through a metering cylinder or metering pump 1112 into a recirculation mix head inlet line 1114. The recirculation mix head 1116 receives isocyanate and polyol, mixes them, and provides for them to be fed through nozzle 1118 into injection mold 1120. The injection mold 1120 has a top mold 1122 and a bottom mold 1124. Mold heating or cooling can be performed through lines 1126 in the top mold 1122 and lines 1140 in the bottom mold 1124. The materials are kept under controlled temperature conditions to insure that the desired reaction profile is maintained.

The polyol component typically contains additives, such as stabilizers, flow modifiers, catalysts, combustion modifiers, blowing agents, fillers, pigments, optical brighteners, and release agents to modify physical characteristics of the cover. Recycled polyurethane/polyurea also can be added to the core. Polyurethane/polyurea constituent molecules that were derived from recycled polyurethane can be added in the polyol component.

Inside the mix head 1116, injector nozzles impinge the isocyanate and polyol at ultra-high velocity to provide excellent mixing. Additional mixing preferably is conducted using an aftermixer 1130, which typically is constructed inside the mold between the mix head and the mold cavity.

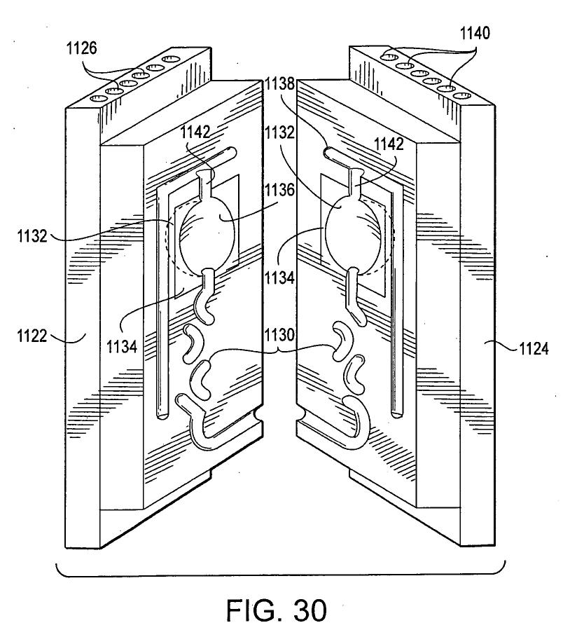

As is shown in FIG. 30, the mold includes a golf ball cavity chamber 1132 in which a spherical golf ball cavity 1134 with a dimpled, inner spherical surface 1136 is defined. The aftermixer 1130 can be a peanut aftermixer, as is shown in FIG. 30, or in some cases another suitable type, such as a heart, harp or dipper. However, the aftermixer does not have to be incorporated into the mold design. An overflow channel 1138 receives overflow material from the golf ball cavity 1134 through a shallow vent 1142. Heating/cooling passages 1126 and 1140, which preferably are in a parallel flow arrangement, carry heat transfer fluids such as water, oil, etc. through the top mold 1122 and the bottom mold 1124.

The mold cavity can optionally utilize retractable pins for support of a golf ball core or intermediate golf ball assembly placed within the molding cavity, such as when molding a cover layer thereon. Alternately, a plurality-of deep dimple projections can be provided on the molding surface to support and center the core or ball assembly. The molding members are generally constructed in the same manner as a mold used to injection mold a thermoplastic, e.g., ionomeric golf ball cover. However, two differences when RIM is used are that tighter pin tolerances generally are required, and a lower injection pressure is used. Also, the molds can be produced from lower strength material such as aluminum. Furthermore, indirect heating and/or cooling of the mold through the use of heated or cooled press platens may allow for yet more simplistic mold constructions.

In accordance with conventional molding techniques, the preferred embodiment molding processes described herein may utilize one or more mold release agents to facilitate removal of the molded layer or component from the mold. However, it is contemplated that typically, such agents will not be required.

A golf ball manufactured according the preferred methods described herein exhibits unique characteristics. Golf ball covers made through compression molding and traditional injection molding include balata, isomer resins, polyesters resins and polyurethanes/polyureas. The selection of polyurethanes which can be processed by these methods is limited. Polyurethanes are often a desirable material for golf ball covers because balls made with these covers are more resistant to scuffing and resistant to deformation than balls made with covers of other materials. The exemplary embodiment allows processing of a wide array of grades of polyurethane through RIM which was not previously possible or commercially practical utilizing either compression molding or traditional injection molding. For example, utilizing the exemplary embodiment method and VIBRARIM reaction injection moldable polyurethane and polyurea systems from Crompton Corporation (Middlebury, Conn.), a golf ball with the properties described below has been provided. It is anticipated that other urethane resins such as Bayer® MP-1000, Bayer® MP-7500, Bayer® MP-5000, Bayer® aliphatic or light stable resins, and Uniroyal® alihatic and aromatic resins may be used.

Some of the unique characteristics exhibited by a golf ball according to the exemplary embodiment include a thinner cover without the accompanying disadvantages otherwise associated with relatively thin covers such as weakened regions at which inconsistent compositional differences exist. A traditional golf ball cover typically has a thickness in the range of about 0.060 inch to 0.080 inch. A golf ball of the exemplary embodiment may utilize a cover having a thickness of about 0.0015 inch to about 0.050 inch. This reduced cover thickness is often a desirable characteristic. It is contemplated that thinner layer thicknesses are possible using the exemplary embodiment.

Because of the reduced pressure involved in RIM as compared to traditional injection molding, a cover or any other layer of the exemplary embodiment golf ball is more dependably concentric and uniform with the core of the ball, thereby improving ball performance. That is, a more uniform and reproducible geometry is attainable by employing the exemplary embodiment.

Utilizing the preferred aspects described herein, cosmetics and durability of the resulting golf balls can be significantly improved since locating pins for the core or the intermediate assembly can be eliminated. Such pins are generally otherwise required during molding operations.

Along with cosmetic and durability benefits, the preferred embodiment golf balls are not damaged during ejection such as otherwise might occur using a single pin. The preferred embodiment ejection pin utilizes a tip having a relatively large surface area so that the impact force used to displace the ball from the molding cavity is distributed over a relatively large surface area on the ball.

Preferably, the aerodynamic pattern defined on the molding surfaces of the molds is such that no dimple or other aerodynamic geometry extends between molds. Thus, the resulting flash on the molded ball is confined to the land area between dimples. This also results in a more aerodynamically efficient golf ball.

The golf balls formed according to the exemplary embodiments can be coated using a conventional two-component spray coating or can be coated during the RIM process, i.e., using an in-mold coating process.

One of the significant advantages of the RIM process according to the exemplary embodiment is that polyurethane/polyurea or other cover materials can be recycled and used in golf ball cores. Recycling can be conducted by, e.g., glycolysis. Typically, 10 to 90% of the material which is injection molded actually becomes part of the cover. The remaining 10 to 90% is recycled.

Recycling of polyurethanes by glycolysis is known from, for example, RIM Part and Mold Design—Polyurethanes, 1995, Bayer Corp., Pittsburgh, Pa. Another significant advantage of the exemplary embodiment is that because reaction injection molding occurs at low temperatures and pressures, i.e., 90 to 180° F. and 50 to 200 psi, this process is particularly beneficial when a cover is to be molded over a very soft core. When higher pressures are used for molding over soft cores, the cores “shut off” i.e., deform and impede the flow of material causing uneven distribution of cover material.

Golf ball cores also can be made using the materials and processes of the exemplary embodiment. To make a golf ball core using RIM polyurethane, the same processing conditions are used as are described above with respect to covers. One difference is, of course, that no deep dimple projections or retractor pins are needed in the mold. Furthermore, an undimpled, smaller mold is used. If, however, a one piece ball is desired, a dimpled mold would be used. Polyurethanes/polyureas also can be used for cores. Furthermore, fast-chemical-reacting systems comprising one or more polybutadiene based components may be used for cores.

Golf balls typically have indicia and/or logos stamped or formed thereon. Such indicia can be applied by printing using a material or a source of energetic particles after the ball core and/or cover have been reaction-injection-molded according to the exemplary embodiment. Printed indicia can be formed from a material such as ink, foil (for use in foil transfer), etc. Indicia printed using a source of energetic particles or radiation can be applied by burning with a laser, burning with heat, directed electrons, or light, phototransformations of, e.g., UV ink, impingement by particles, impingement by electromagnetic radiation, etc. Furthermore, the indicia can be applied in the same manner as an in-mold coating, i.e., by applying to the indicia to the surface of the mold prior to molding of the cover.

The polyurethane which is selected for use as a golf ball cover preferably has a Shore B hardness of 10 to 95, more preferably 30 to 75, and most preferably 30 to 50 for a soft cover layer and 50 to 75 for a hard cover layer. The polyurethane which is to be used for a cover layer preferably has a flex modulus of 1 to 310 kpsi, more preferably 5 to 100 kpsi, and most preferably 5 to 20 kpsi for a soft cover layer and 30 to 70 kpsi for a hard cover layer.

Other soft, relatively low modulus non-ionomeric thermoplastic or thermoset polyurethanes may also be utilized to produce the inner and/or outer cover layers as long as the non-ionomeric materials produce the playability and durability characteristics desired without adversely affecting the enhanced travel distance characteristic produced by the high acid isomer resin composition. These include, but are not limited to thermoplastic polyurethanes such as Texin® thermoplastic polyurethanes from Mobay chemical Co. and the Pellethane® thermoplastic polyurethanes from Dow Chemical Co.; non-ionomeric thermoset polyurethanes including but not limited to those disclosed in U.S. Pat. No. 5,334,673.

Non-limiting examples of suitable RIM systems for use in the exemplary embodiment are VIBRARIM polyurethane/polyurea systems from Crompton Corporation (Middlebury, Conn.) and the Bayflex7 elastomeric polyurethane RIM systems, Baydur7 GS solid polyurethane RIM systems, Prism7 solid polyurethane RIM systems, all from Bayer Corp. (Pittsburgh, Pa.), SPECTRIM reaction moldable polyurethane and polyurea systems from Dow Chemical USA (Midland, Mich.), including SPECTRIM MM 373-A (isocyanate) and 373-B (polyol), and Elastolit SR systems from BASF (Parsippany, N.J.).

Several systems available from Bayer include Bayflex 110-50 and Bayflex MP-10,000.

Bayflex ®
Polyurethane Elastomeric RIM

| | ASTM Test | U.S. | 110-50 | | | 110-50 | MP- |
|---|---|---|---|---|---|---|---|
| | Method | Conventional | | 15% | 15% | CM | 10,000 |
| Typical Properties | (Other) | Units | Unfilled | Glass¹ | Mineral² | Unfilled | Unfilled |
| GENERAL | | | | | | | |
| Specific Gravity | D 792 | | 1.04 | 1.14 | 1.15 | 1.04 | 1.1 |
| Density | D 1622 | lb/ft³ | 64.9 | 71.2 | 71.8 | 64.9 | 68.7 |
| Thickness | | in | 0.125 | 0.125 | 0.125 | 0.125 | 0.118 |
| Shore Hardness | D 2240 | A or D | 58 D | 60 D | 60 D | 51 D | 90 A |
| Mold Shrinkage | (Bayer) | % | 1.3 | 0.7 | 0.6 | 1.3 | 1.42 |
| Water Immersion, Length Increase | (Bayer) | in/in | 0.006 | 0.002 | | | 0.014 |
| Water Absorption: | (Bayer) | | | | | | |
| 24 Hours | | % | | | | | 3.3 |
| 240 Hours | | % | 2.8 | 2.6 | | | 5.0 |
| MECHANICAL | | | | | | | |
| Tensile Strength, Ultimate | D 638/D 412 | lb/in² | 3,500 | 2,800 | 3,300 | 3,300 | 2,200 |
| Elongation at Break | D 638/D 412 | % | 250 | 200 | 140 | 360 | 300 |
| Flexural Modulus: | D 790 | | | | | | |
| 149° F. | | lb/in² | 38,000 | 60,000 | 111,000 | 27,000 | 7,900 |
| 73° F. | | lb/in² | 52,000 | 100,000 | 125,000 | 46,000 | 10,000 |
| −22° F. | | lb/in² | 115,000 | 160,000 | 250,000 | 97,000 | 23,600 |
| Tear Strength, Die C | D-624 | lbf/in | 450 | 620 | 640 | 500 | 240 |
| Impact Strength: | D 256 | | 450 | 620 | 640 | 500 | 240 |
| Notched Izod | | ft lb/in | 11 | 8 | 3 | 9 | |
| THERMAL | | | | | | | |
| Heat Sag: | D 3769 | | | | | | |
| 6-in Overhang, 1 hr at 375° F. | | in | | | | | |
| 6-in Overhang, 1 hr at 250° F. | | in | 0.60 | 028 | | | |
| 4-in Ovrhang, 1 hr at 250° F. | | in | 0.36 | 0.27 | 0.16 | 0.6 | |
| Coefficient of Linear Thermal | D 696 | in/in ° F. | 61E−06 | 44E−06 | 27E−06 | 85E−06 | 53E−06 |
| Expansion | | | | | | | |
| FLAMMABILITY | | | | | | | |
| UL94 Flame Class: | (UL94) | | | | | | |
| 0.125-in (3.18-mm) Thickness | | Rating | HB | | | V-2 | |

¹Milled glass fiber, OCF 737, 1/16 inch.
²RRIMGLOS 10013 (RRIMGLOS is a trademark of NYCO Minerals, Inc.).
Note 1
All directional properties are listed parallel to flow.

BAYFLEX MP-10,000 is a two component system, consisting of Component A and Component B. Component A comprises the diisocyanate and Component B comprises the polyether polyol plus additional curatives, extenders, etc. The following information is provided by the BAYFLEX MP-10,000 MSDS sheet, regarding the constituent components.

Component A

| 1. | Chemical Product Information (Section 1) | |
|---|---|---|
| | Product Name: | BAYFLEX MP-10,000 Component A |
| | Chemical Family: | Aromatic Isocyanate Prepolymer |
| | Chemical Name: | Diphenylmethane Diisocyanate |
| | | (MDI) Prepolymer |
| | Synonyms: | Modified Diphenylmethane Diisocyanate |

| 2. | Composition/Information on Ingredients (Section 2) | |
|---|---|---|
| | Ingredient | Concentration |
| | 4,4′-Diphenylmethane Diisocyanate (MDI) | 53-54% |
| | Diphenylmethane Diisocyanate (MDI) (2,2; 2,4) | 1-10% |

| 3. | Physical and Chemical Properties (Section 9) | |
|---|---|---|
| | Molecular Weight: | Average 600-700 |

| 4. | Regulatory Information (Section 15) | |
|---|---|---|
| | Component | Concentration |
| | 4,4′-Diphenylmethane Diisocyanate (MDI) | 53-54% |
| | Diphenylmethane Diisocyanate (MDI) (2,2; 2,4) | 1-10% |
| | Polyurethane Prepolymer | 40-50% |

Component B

| 1. | Chemical Product Information (Section 1) | |
|---|---|---|
| | Product Name: | BAYFLEX MP-10,000 Component B |
| | Chemical Family: | Polyether Polyol System |
| | Chemical Name: | Polyether Polyol containing |
| | | Diethyltoluenediamine |

| 2. | Composition/Information on Ingredients (Section 2) | |
|---|---|---|
| | Ingredient | Concentration |
| | Diethyltoluenediamine | 5-15% |

| 3. | Transportation Information (Section 14) | |
|---|---|---|
| | Technical Shipping Name: | Polyether Polyol System |
| | Freight Class Bulk: | Polypropylene Glycol |
| | Freight Class Package: | Polypropylene Glycol |

| 4. | Regulatory Information (Section 15) | |
|---|---|---|
| | Component Name | Concentration |
| | Diethyltoluenediamine | 5-15% |
| | Pigment dispersion | Less than 5% |
| | Polyether Polyol | 80-90% |

Additionally, Bayer reports the following further information:

Component A

| | |
|---|---|
| Isocyanate: | 4,4 diphenylmethane diisocyanate (MDI) |
| Functionality: | 2.0 |
| Curing Agents: | None |
| Diisocyanate | 60% free MDI; remaining 40% has reacted |
| Concentration: | |
| % NCO: | 22.6 (overall) |
| Equivalent Weight: | 186 |

Component B

| | |
|---|---|
| Polyol: | Trio containing derivatives of polypropylene glycol |
| Functionality: | 3.0 |
| Equivalent Weight: | 2,000 |
| Amine Extender: | Diethyltoluenediamine (equivalent weight of 88) |

According to Bayer, the following general properties are produced by this RIM system:

| | | | ASTM Test |
|---|---|---|---|
| Property | Typical Physical Properties | Value | Method |
| General | Specific Gravity | 1.1 | D 792 |
| | Density | 68.7 lb/ft³ | D 1622 |
| | Thickness | 0.118 in | |
| | Shore Hardness | 90 A, 110 D | D 2240 |
| | Mold Shrinkage | 1.42% | (Bayer) |
| | Water Immersion, Length Increase | 0.014 in/in | (Bayer) |
| | Water Absorption: 24 Hours | 3.3% | (Bayer) |
| | Water Absorption: 240 Hours | 5.0% | (Bayer) |
| Mechanical | Tensile Strength, Ultimate | 2,200 lb/in² | D 638/D 412 |
| | Elongation at Break | 300% | D 638/D 412 |
| | Flexural Modulus: 149° F. | 7,900 lb/in² | D 790 |
| | Flexural Modulus: 73° F. | 10,000 lb/in² | D 790 |
| | Flexural Modulus: −22° F. | 23,600 lb/in² | D 790 |
| | Tear Strength, Die C | 240 lbf/in | D 624 |
| Thermal | Coefficient of Linear Thermal Expansion | 53E−06 in/in/° F. | D 696 |

Another suitable polyurethane/polyurea RIM system suitable for use with the exemplary embodiment is the VibraRIM system:

VibraRIM 813A
(ISO Component)
Physical Properties

| ATTRIBUTE | SPECIFICATION |
|---|---|
| % NCIO | 16.38-16.78 |
| Viscosity | 400-800 cps at 50 C. with #2 spindle @ 20 rpm |
| Color | Hellige Comparator: Gardner 3 max W/CL-620C-40 |

VibraRIM 813B
(Polyol Component)
Physical Properties

| ATTRIBUTE | SPECIFICATION |
|---|---|
| Equivalent Weight | TBD - Theoretical 270.5 +/−5 |
| Viscosity | 100-200 cps at 50 C. (#2 spindle/20 rpm) |
| Color | WHITE - 4.84% PLASTICOLORS DR-10368 |
| Moisture | 0.10% Maximum |
| Reactivity | COA for charge weight of catalyst |
| Mixing | COA for charge weight of surfactant |

VibraRIM 813A (Iso) and 813B (Polyol) are available from Crompton Chemical, now Chemtura of Middlebury, Conn.

A sample plaque formed from the VibraRIM 813A and 813B components exhibited the following representative properties:

Plaque material Shore D (peak)=39

Specific gravity 1.098 g/cc

Flexural mod. (ASTM D 790)=7920 psi.

300% mod. (ASTM D 412)=2650 psi.

Young's mod. at 23 C (DMA)=75.5 MPa

Shear mod. at 23C (DMA)=11.6 MPa

In a particularly preferred form of the exemplary embodiments, at least one layer of the golf ball contains at least one part by weight of a filler. Fillers preferably are used to adjust the density, flex modulus, mold release, and/or melt flow index of a layer. More preferably, at least when the filler is for adjustment of density or flex modulus of a layer, it is present in an amount of at least 5 parts by weight based upon 100 parts by weight of the layer composition. With some fillers, up to about 200 parts by weight probably can be used.

A density adjusting filler according to the exemplary embodiment preferably is a filler which has a specific gravity which is at least 0.05 and more preferably at least 0.1 higher or lower than the specific gravity of the layer composition. Particularly preferred density adjusting fillers have specific gravities which are higher than the specific gravity of the resin composition by 0.2 or more, and even more preferably by 2.0 or more.

A flex modulus adjusting filler according to the exemplary embodiment is a filler which, e.g. when used in an amount of 1 to 100 parts by weight based upon 100 parts by weight of resin composition, will raise or lower the flex modulus (ASTM D-790) of the resin composition by at least 1% and preferably at least 5% as compared to the flex modulus of the resin composition without the inclusion of the flex modulus adjusting filler.

A mold release adjusting filler is a filler which allows for the easier removal of a part from a mold, and eliminates or reduces the need for external release agents which otherwise could be applied to the mold. A mold release adjusting filler typically is used in an amount of up to about 2 weight percent based upon the total weight of the layer.

A melt flow index adjusting filler is a filler which increases or decreases the melt flow, or ease of processing of the composition.

The layers may contain coupling agents that increase adhesion of materials within a particular layer, e.g. to couple a filler to a resin composition, or between adjacent layers. Non-limiting examples of coupling agents include titanates, zirconates and silanes. Coupling agents typically are used in amounts of 0.1 to 2 weight percent based upon the total weight of the composition in which the coupling agent is included.

A density adjusting filler is used to control the moment of inertia, and thus the initial spin rate of the ball and spin decay. The addition in one or more layers, and particularly in the outer cover layer of a filler with a lower specific gravity than the resin composition results in a decrease in moment of inertia and a higher initial spin rate than would result if no filler were used. The addition in one or more of the cover layers, and particularly in the outer cover layer of a filler with a higher specific gravity than the resin composition, results in an increase in moment of inertia and a lower initial spin rate. High specific gravity fillers are preferred as less volume is used to achieve the desired inner cover total weight. Nonreinforcing fillers are also preferred as they have minimal effect on COR. Preferably, the filler does not chemically react with the resin composition to a substantial degree, although some reaction may occur when, for example, zinc oxide is used in a shell layer which contains some isomer.

The density-increasing fillers for use in the exemplary embodiment preferably have a specific gravity in the range of 1.0 to 20. The density-reducing fillers for use in the exemplary embodiment preferably have a specific gravity of 0.06 to 1.4, and more preferably 0.06 to 0.90. The flex modulus increasing fillers have a reinforcing or stiffening effect due to their morphology, their interaction with the resin, or their inherent physical properties. The flex modulus reducing fillers have an opposite effect due to their relatively flexible properties compared to the matrix resin. The melt flow index increasing fillers have a flow enhancing effect due to their relatively high melt flow versus the matrix. The melt flow index decreasing fillers have an opposite effect due to their relatively low melt flow index versus the matrix.

Fillers which may be employed in layers other than the outer cover layer may be or are typically in a finely divided form, for example, in a size generally less than about 20 mesh, preferably less than about 100 mesh U.S. standard size, except for fibers and flock, which are generally elongated. Flock and fiber sizes should be small enough to facilitate processing. Filler particle size will depend upon desired effect, cost, ease of addition, and dusting considerations. The filler preferably is selected from the group consisting of precipitated hydrated silica, clay, talc, asbestos, glass fibers, aramid fibers, mica, calcium metasilicate, barium sulfate, zinc sulfide, lithopone, silicates, silicon carbide, diatomaceous earth, polyvinyl chloride, carbonates, metals, metal alloys, tungsten carbide, metal oxides, metal stearates, particulate carbonaceous materials, micro balloons, and combinations thereof.

A wide array of materials may be used for the cores and mantle layer(s) of the exemplary embodiment golf balls. For instance, the core and mantle or interior layer materials disclosed in U.S. Pat. Nos. 5,833,553, 5,830,087 and 5,820,489 may be employed. All patents and patent applications cited in the foregoing text are expressly incorporated herein by reference in their entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

1. A molding assembly adapted for reaction injection molding of a golf ball or component thereof, the molding assembly comprising:
a first mold defining a first molding surface and a first lip region extending around the periphery of the first molding surface; and
a second mold defining a second molding surface and a second lip region extending around the periphery of the second molding surface;
wherein the first mold and the second mold engage each other such that the first molding surface and the second molding surface define a molding chamber sized to accommodate a golf ball, and the first mold and the second mold define a non-planar parting line configuration having (i) a mold parting line, and (ii) a lip parting line, the mold parting line includes at least one of a linear segment and an arcuate segment, and the lip parting line includes at least two segments, each of which includes at least one of a linear segment and an arcuate segment.

2. The molding assembly of claim 1 wherein the mold parting line includes a plurality of linear segments oriented in a zigzag pattern.

3. The molding assembly of claim 1 wherein the mold parting line includes a plurality of linear segments oriented in a step pattern.

4. The molding assembly of claim 1 wherein the mold parting line includes a plurality of arcuate segments.

5. The molding assembly of claim 1 wherein the lip parting line includes two segments which are each linear.

6. The molding assembly of claim 5 wherein the lip parting line segments are parallel to one another.

7. The molding assembly of claim 5 wherein the lip parting line segments extend at an angle with respect to each other.

8. The molding assembly of claim 5 wherein the lip parting line segments extend within a common plane.

9. The molding assembly of claim 1 wherein the lip parting line segments are each arcuate.

10. The molding assembly of claim 1 wherein each lip parting line segment includes a plurality of linear segments.

11. The molding assembly of claim 10 wherein each lip parting line segment includes a plurality of arcuate segments.

12. A molding assembly adapted for reaction injection molding a golf ball or component thereof, the molding assembly comprising:
a first mold defining a first molding surface and a first lip region extending around the periphery of the first molding surface; and
a second mold defining a second molding surface and a second lip region extending around the periphery of the second molding surface;
wherein the first mold and the second mold engage each other such that the first molding surface and the second molding surface define a molding chamber, and the first mold and the second mold define a non-planar parting line configuration having (i) a mold parting line, and (ii) a lip parting line including two segments, each segment extending along a line of symmetry, the mold parting line includes at least one of a linear segment and an arcuate segment, and the line of symmetry for each of the lip parting line segments being linear or arcuate.

13. The molding assembly of claim 12 wherein the mold parting line includes a plurality of linear segments oriented in a zigzag pattern.

14. The molding assembly of claim 12 wherein the mold parting line includes a plurality of linear segments oriented in a step pattern.

15. A molding assembly adapted for reaction injection molding a golf ball or component thereof, the molding assembly comprising:
a first mold defining a first molding surface and a first lip region extending around the periphery of the first molding surface; and
a second mold defining a second molding surface and a second lip region extending around the periphery of the second molding surface;
wherein the first mold and the second mold engage each other such that the first molding surface and the second molding surface define a molding chamber, and the first mold and the second mold define a non-planar parting line configuration having (i) a mold parting line extending along a first line of symmetry, and (ii) a lip parting line including two segments, each segment extending along at least another line of symmetry, the first line of symmetry of the mold parting line being linear or arcuate, and the at least another line of symmetry of the lip parting line segments being linear or arcuate.

16. The molding assembly of claim 21 wherein the first line of symmetry of the mold parting line is linear.

17. The molding assembly of claim 21 wherein the first line of symmetry of the mold parting line is arcuate.

18. A molding assembly adapted for reaction injection molding a golf ball or component thereof, the molding assembly comprising:
a first mold defining a first molding surface and a first lip region extending around the periphery of the first molding surface; and
a second mold defining a second molding surface and a second lip region extending around the periphery of the second molding surface;
wherein the first mold and the second mold engage each other such that the first molding surface and the second molding surface define a molding chamber, and the first mold and the second mold define a non-planar parting line configuration having (i) a mold parting line extending along a line of symmetry, and (ii) a lip parting line including two segments, the line of symmetry of the mold parting line is linear or arcuate, and each of the lip parting line segments includes at least one of a linear segment and an arcuate segment.
